(19) United States
(12) Patent Application Publication
(10) Pub. No.: US 2009/0055632 A1
(43) Pub. Date: Feb. 26, 2009

(54) Emulation Scheme for Programmable Pipeline Fabric

(76) Inventor: Chao-Wu Chen, San Jose, CA (US)

Correspondence Address: PILLSBURY WINTHROP SHAW PITTMAN LLP, P.O. BOX 10500, MCLEAN, VA, 22102, US

(21) Appl. No.: 11/843,596

(22) Filed: Aug. 22, 2007

(51) Int. Cl. G06F 9/30

(52) U.S. Cl. 712/227; 712/E09.032

(57) ABSTRACT

The present invention allows emulation of a programmable pipeline processor fabric or architecture. According to certain aspects, the invention permits real-time capture of state information for any given stage of a processing flow performed by the fabric or architecture. According to other aspects, the invention allows a particular stage and data set of a SIMD flow to be analyzed. According to other aspects, the invention utilizes an independent clocking domain for the capture of state information.

### FIELD OF THE INVENTION

The present invention relates to programmable pipeline fabrics, and more particularly to methods and apparatuses for providing for real-time capture of internal state of individual processing elements within the fabric for a desired step of a program implemented by the fabric.

### BACKGROUND OF THE INVENTION

A programmable pipeline fabric has been developed that dramatically advanced the state of the art of microprocessors. Details regarding the construction and operation of this type of processor may be found in Schmit, et al, “PipeRench: a virtualized programmable data path in 0.18 Micron Technology”, in Proceedings of the IEEE Custom Integrated Circuits Conference (CICC), 2002, the entirety of which is hereby incorporated by reference, Schmit, “PipeRench: a reconfigurable architecture and compiler”, IEEE Computer, pages 70-76 (April 2000), the entirety of which is hereby incorporated by reference, Schmit, “Incremental Reconfiguration for Pipelined Applications”, Proceedings of the IEEE Symposium on FPGAs for Custom Computing Machines, pp. 47-55, 1997, the entirety of which is hereby incorporated by reference, Schmit et al, “PipeRench: A Coprocessor for Streaming Multimedia Acceleration”, International Symposium on Computer Architecture, pp. 38-49, 1999, the entirety of which is hereby incorporated by reference, and Schmit, et al, “Managing Pipeline-Reconfigurable FPGAs” published in ACM 6th International Symposium on FPGAs, February 1998, the entirety of which is hereby incorporated by reference. Certain additional novel aspects of this technology have been described in U.S. Pat. No. 7,131,017 and Ser. No. 10/222,645, the contents of which are incorporated herein by reference.

FIG. 1 is a top-level block diagram illustrating a integrated circuit chip 100 having an embedded reconfigurable processor 102 in accordance with certain principles of the above publications and patents. As shown in FIG. 1, an architecture according to this technology includes configuration control and cache coupled to the reconfigurable fabric 102. Configuration data stored in the cache (e.g. SRAM) can be used to reconfigure the reconfigurable fabric 102 as needed. This configuration data can include, for example, instructions and routing information for each processor in the array. According to certain beneficial aspects, the stored configurations can be loaded into the fabric 102 “just-in-time” in conjunction with desired operations and data. Moreover, the cache is reloadable.

FIG. 2 is a block diagram illustrating aspects of an example reconfigurable fabric 102 in more detail. As shown in FIG. 2, the reconfigurable fabric 102 in this example is comprised of stripes, each containing a number of processing elements (PEs). In one example there are 16 stripes containing 16 PEs. As further shown in FIG. 2, a configuration store (corresponding to the cache in FIG. 1) provides configuration data to PEs in each stripe via a global bus. In one example, each stripe can be configured with 672 bits of configuration data (e.g. 42 bits for each of the 16 PEs in the stripe), and so this bus is 672 bits wide. The configuration cache is sized to store 256 words containing 672 bits each of configuration information, i.e. a 256-stripe or pipeline stage program. Meanwhile, data is input and output from the fabric through input and output queues, respectively, and global data busses coupled to each stripe. Moreover, data is passed between PEs of each stripe via local inter-stripe connections (i.e. pipeline).

While the above architecture is in many ways superior to existing architectures, improvements are still possible. For example, compared to conventional processors and architectures, it is not as straightforward to debug applications or emulate performance of the programmable pipeline fabric/architecture described above. Whereas typical CPUs include tools such as debuggers, and embedded processors can be debugged using tools such as in-circuit emulators (ICE) to provide real-time capture of internal state, similar tasks are not as straightforward in the pipelined architecture described above, especially in a single-instruction multiple data (SIMD) programming flow, and further when the pipeline fabric is embedded within an integrated circuit.

More specifically, as shown in FIG. 2, if a developer desires to know how a program is performing at a given processing stage and with a given type of data, the processor would be operated in real-time and then the entire input data streams, output data streams and program streams would need to be dumped and analyzed. Meanwhile, the internal states of the of the PEs themselves (such as internal registers, etc.) are still hidden and cannot be readily ascertained from the input, output and program data. Accordingly, development and verification of programs can take a long time, and performance may not be completely reliable.

Accordingly, it would be desirable to have a scheme for emulating performance of a pipelined architecture, including means for providing real-time capture of internal state of desired elements and programming steps within the architecture at any given time.

### SUMMARY OF THE INVENTION

The present invention allows emulation of a programmable pipeline processor fabric or architecture. According to certain aspects, the invention permits real-time capture of state information for any given stage of a processing flow performed by the fabric or architecture. According to other aspects, the invention allows a particular stage and data set of a SIMD flow to be analyzed. According to other aspects, the invention utilizes an independent clocking domain for the capture of state information.

In accordance with these and other aspects, an apparatus according to invention includes a real-time capture block that controllably captures internal state from selected programmable elements in a pipeline fabric. In further accordance with these and other aspects, a method according the invention includes controllably capturing internal state from selected programmable elements in a pipeline fabric in real time.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram of a conventional reconfigurable array architecture;

FIG. 2 is a block diagram of an example implementation of a reconfigurable array architecture in which processor stripes are configured by information stored in a configuration cache external to the array;

FIG. 3 is a block diagram illustrating aspects of real-time capture of information from a programmable pipeline fabric according to the invention;

FIG. 4 is a block diagram illustrating embodiments of a programmable pipeline fabric having real-time capture functionality according to the invention; and

FIG. 5 is a block diagram illustrating an example implementation of a real-time capture block that can be integrated in a programmable pipeline fabric according to embodiments of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

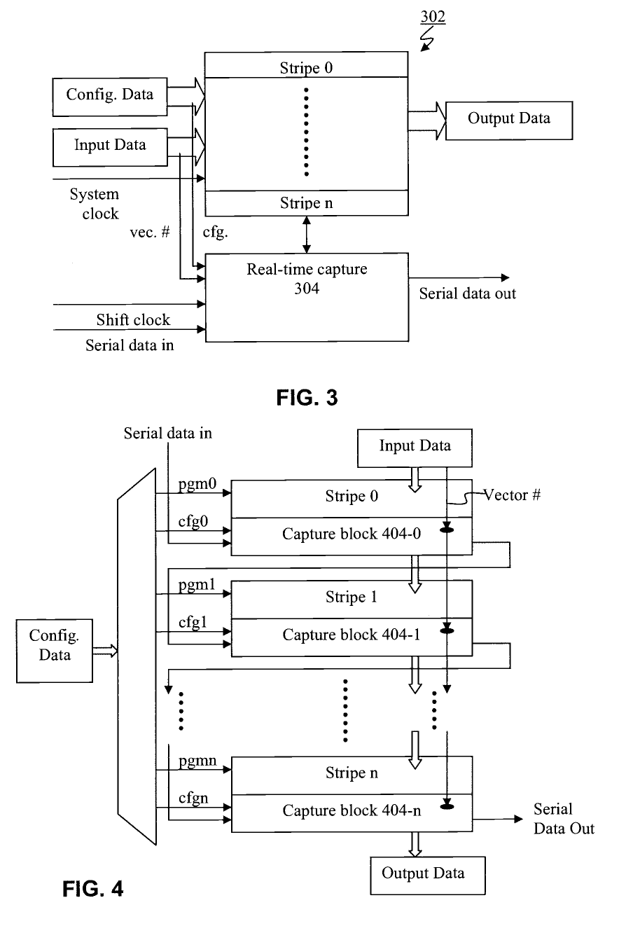

In general, the present invention allows real-time capture of internal state of any processor(s) within any given pipeline stage(s) and/or data set(s) (i.e. vector) in a programmable pipeline fabric. A block diagram illustrating certain general aspects of the invention is shown in FIG. 3. As shown in FIG. 3, a real-time capture block 304 is coupled to the programmable pipeline fabric 302. Although the block 304 is shown separately from fabric 302 in FIG. 3 for purposes of illustration, it is likely that circuitry comprising block 304 may be integrally provided together with fabric 302. Moreover, it should be noted that in some embodiments, block 304 is provided together with fabric 302 on the same integrated circuit chip or SOC. In other embodiments, they are provided on separate chips. Certain implementation aspects and alternatives will become even more apparent from the descriptions below, but the invention is not limited by such implementation details.

In the example of FIG. 3, block 304 uses certain information to determine what data to capture from fabric 302. In this example, the information includes a stage ID and vector number associated with the configuration data and input data, respectively, that is provided to fabric 302. In addition, block 304 receives a shift clock that is used to clock controls, data and other information via serial input data into block 304, as well as to clock out captured data and other information from block 304 via serial output data. This makes it possible for the capturing functionality to be controlled and to operate independently from, and without interrupting, the overall system performance.

In general, the capture select data input to block 304 via the stage ID, vector number and/or serial data, includes data that selects the pipeline stage and input data for which state data is desired to be captured. This allows precise identification of both the processing that is desired to be analyzed, as well as the data that the processing acts upon, which can be important in certain processing flows such as single-instruction, multiple data flows (SIMD). It should be noted that for other types of processing flows, just one of the instruction stage and data set may need to be identified, and the invention encompasses such embodiments. The selection data can further include information regarding the particular type of data to be captured (for example, a particular subset of state information corresponding to a particular processing element within a physical stripe corresponding to the pipeline stage).

In embodiments, fabric 302 can be implemented by a programmable pipeline fabric such as a Kilocore fabric from Rapport, Incorporated of Redwood City, Calif., aspects of which are described in the prior publications, patents and applications referred to above. Accordingly, as described in those references, the configuration data includes instructions to be executed by processing elements in stripes 0 to n, using input data supplied to the fabric 302, and resulting in output data that is output from the fabric 302. The selection data provided to block 304, as made possible by adding the functionality and circuitry of the present invention to fabric 302, thus allows the internal state of a particular processing element that is executing a particular set of instructions provided in the configuration data on a particular vector provided in the input data, in a manner that has not been previously possible. In one example using the Kilocore fabric, the vector number associated with the input is conventionally provided and propagated within the fabric 302, and so the invention taps this existing information within the fabric. The manner of identifying the particular set of instructions to view via a stage ID bit will become more apparent from the descriptions below.

Regardless of the particular implementation details of fabric 302 (i.e. whether it is a Kilocore or other fabric), the operation principles of the invention can be substantially the same. A program is loaded into the processor by loading the configuration data with the instructions and other information. In conjunction with this step, the instruction/pipeline stage to be analyzed is identified, and this identification information (i.e. stage ID) is loaded together with the configuration data. In certain applications, it is also desired to analyze the execution of instructions with certain sets of data or vectors (i.e. the set of data operated on by a stripe during a given pipeline stage or processing sequence). Accordingly, included with the input data is a vector number associated with each set of data that is provided to the stripes. Concurrently with or prior to program execution, capture select data can further be clocked into the real-time capture block 304 using the shift clock. In embodiments, the data is provided serially, and the shift clock operates in an emulation clock domain or operation that is separate from the real-time system clock.

During program operation, the fabric 302 is configured with configuration data and input data is provided to the fabric 302 in real-time according to the system clock. When the real-time capture block 304 detects both that (1) the stage ID provided with the configuration data and (2) the vector number provided with the input data matches the stored capture select data, the capture operation is triggered, and the desired state information is extracted from the desired pipeline processor in real-time. The captured data can then be clocked out using the shift clock either concurrently with or following complete program execution.

An example implementation of a pipeline fabric including real-time capture functionality according to embodiments of the invention is illustrated in more detail in FIG. 4.

As shown in FIG. 4, capture block circuitry 404 is integrally provided with the programmable pipeline fabric, such as a Kilocore fabric. Each respective block 404-0 to 404-n is configured to controllably capture real-time state information from an associated stripe 0 to n in accordance with capture select data and information provided with the fabric's configuration data and input data.

More particularly, in one example implementation, input data is provided to the first stripe (i.e. stripe 0) in the pipeline fabric and propagated from stripe to stripe via internal interconnections. It should be apparent that although input data is shown in FIG. 4 as being provided only to the first stripe, and output data is shown being provided from only the last stripe (i.e. stripe n), it is possible in some embodiments that each stripe may receive input data and/or produce output data during any given cycle. Moreover, data may loop from the last stripe (i.e. stripe n) back to the first stripe (i.e. stripe 0).

In any event, in the original Kilocore fabric and other architectures, a vector number associated with the input data is provided together with the input data. In the present invention, capture block 404 in each stripe also receives this vector number, thereby allowing it to uniquely identify the data currently being processed by the associated stripe. FIG. 4 illustrates how the vector number is propagated from the capture block 404 in each stripe to the next stripe along with the input data. This allows the identity of the data in any stripe in any given cycle to be preserved.

As further shown in FIG. 4, configuration data (e.g. program instructions) is controllably provided to a selected stripe in any given cycle. As shown, typically only one stripe is configured in one cycle with configuration data (pgm0 to pgmn). The present invention further allows for a stage ID bit (cfg0 to cfgn) to be controllably provided to the capture block 404 in a given stripe in a given cycle. This information can be used as a trigger to allow for the capture of data from the stripe, in combination with other capture selection information as will be described in more detail below. In embodiments, the stage ID bit (i.e. cfg0 to cfgn) is provided together with the configuration data (i.e. pgm0 to pgmn) in the same stripe.

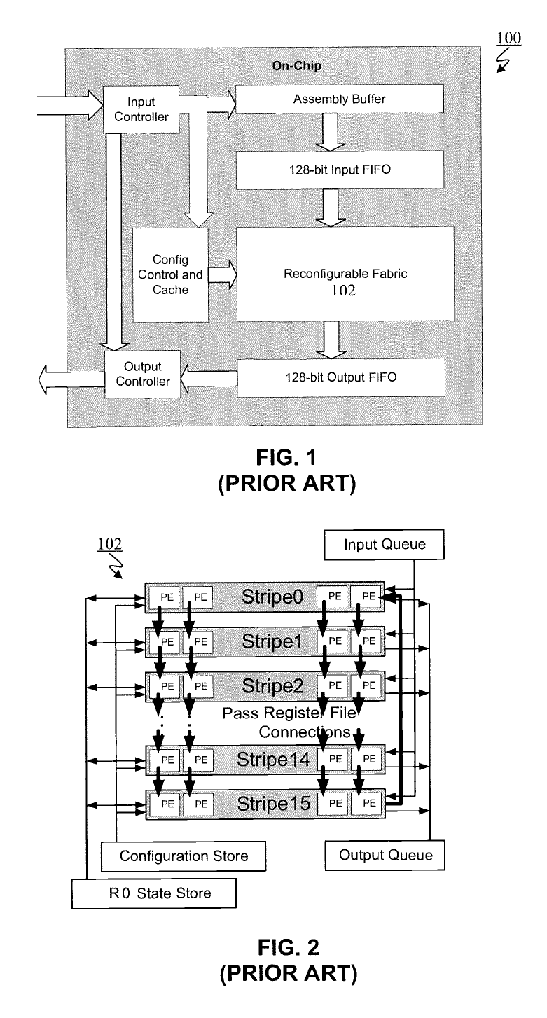

For example, in a Kilocore or similar fabric, a configuration store (corresponding to the cache in FIG. 1) provides configuration data to each stripe via a global bus. In one example, each stripe can be configured with 672 bits of configuration data (e.g. 42 bits for each of the 16 PEs in the stripe), and so this bus is 672 bits wide. The present invention expands this bus by one or more bits to allow for the further provision of the stage ID bit(s) (i.e. cfg) to the stripe. Accordingly, in an example where the stage ID is one bit, the bus is 673 bits wide.

As discussed above, capture select data is clocked into the capture block 404 circuitry serially with a clock (not shown) that is separate from the system clock for the fabric, and captured data is clocked out using the same separate clock. As shown in this example implementation, the serial data is first provided to the capture block 404-0 associated with the first stripe, clocked through that block, and then to capture block 404-1 associated with the second stripe, and continuing on in succession to the capture block 404-n associated with the last stripe. The serial data output from the last capture block 404-n associated with the last stripe can include data captured during an emulation operation.

It should be noted that many variations in the illustrated implementation are possible. For example, even though data will only be captured from one stripe, capture select data can be commonly provided to all stripes. This would be possible because the stage ID bit is used to trigger capture from a particular stripe, and thereby allows simplification of the implementation because it is immaterial what control data is provided to the other stripes. Moreover, since real-time data capture will only be triggered for one stripe at a time, capture data can be output from all stripes and OR-ed to provide the desired capture data. It should be noted, however, that the present invention can be implemented in various additional or alternative ways.

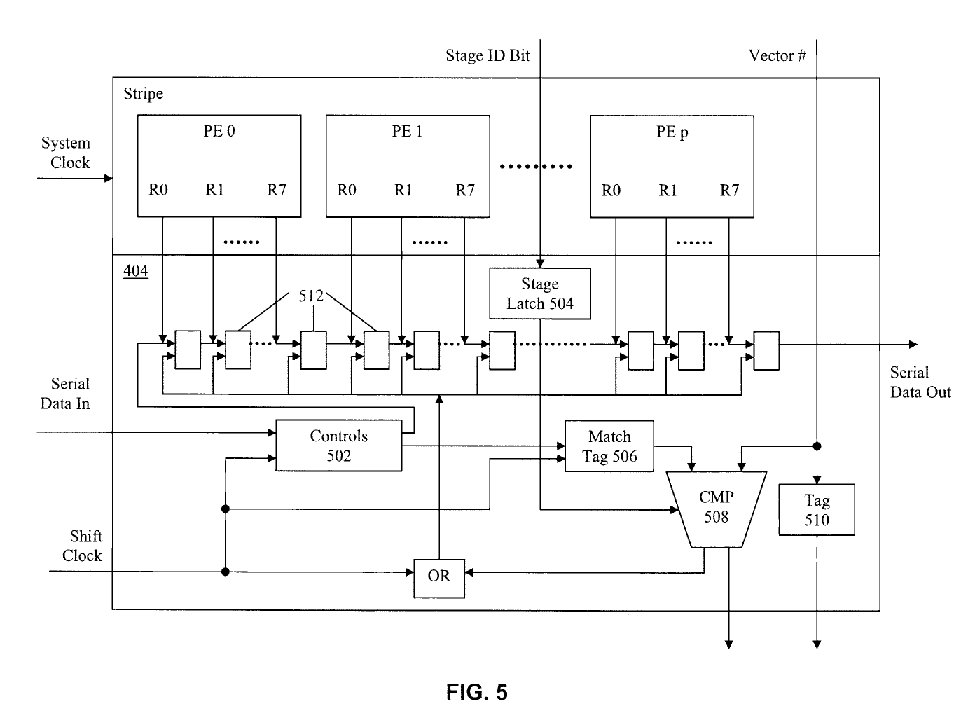

An example implementation of a real-time capture block 404 in accordance with embodiments of the invention is illustrated in more detail in FIG. 5.

As shown in FIG. 5, this example implementation of block 404 includes a capture chain comprised by a plurality of serially-connected latches or flip-flops 512. Each flip-flop 512 has an input tapped to a respective bit of state information from an associated PE. This can include, for example, one bit of an operand or state register. In the example embodiment shown in FIG. 5, the contents of all of the internal registers (e.g. 8 bits of eight registers R0-R7) of the PE can be made available for capture. In one preferred implementation, the capture select data allows a desired subset of these registers to be captured. Moreover, the capture select data allows the subset to be captured for any single one of the PEs. Still further, it is possible to select either the same or different subsets of data to be captured from two or more of the PEs. Other embodiments and variations are possible, as will become even more apparent from the descriptions below.

As further shown in FIG. 5, serial data is shifted into and through the chain of flip flops 512 using either the shift clock or the output of comparator CMP 508, as will become more apparent from descriptions below. Generally, the shift clock is used to configure the flip flops 512 for selecting the appropriate data to be captured via the serial data input to block 404, and the output of comparator CMP 508 is used to capture the data from one or more PEs when the desired program instructions and data are supplied to the stripe. The shift clock can then be used to shift the captured data out of the block 404.

Controls block 502 preferably stores certain of the capture select data received for the associated stripe. This stored select data includes the desired vector number corresponding to the state information to be captured. Controls block 502 parses or copies the vector number from the received capture select data and provides it to match tag register 506, which in turn provides it to one input of comparator 508.

As shown, controls block 502 is in the serial shift path of the serial data input clocked into block 404 by the shift clock. In one example, block 502 is implemented as a shift register or series of flip-flops or similar structures. Since the number of bits held by block 502 will be known, as will be the number of flip-flops 512 in the chain of block 404, it is straightforward how to shift the desired data into precisely the desired locations in block 502 and flip-flops 512 simply based on the number of cycles of the shift clock. Those skilled in the art will further understand how to cause the desired data to be shifted into the proper locations and for the desired block among the stripes simply by knowing the number of flops 512 and the size of block 502 in each block 404, as well as the interconnections between the stripes. Thus, any desired subset of data can be selected from any one or more PEs in any stripe.

The stage ID bit included with the configuration information for a stripe is received by configuration latch 504 along with the configuration data provided to the stripe in any given cycle. When received, latch 504 drives an enable signal to comparator 508.

The vector number associated with the input data that is propagated to the stripe (from a previous stage or stripe, or from an input buffer, for example) is stored in tag register 510. This vector number is provided as the other input to comparator 508. When enabled by the configuration bit from configuration latch 504, comparator 508 compares its inputs to each other and if there is a match, it drives the clocks for the capture chain. Based on the control information clocked into the flip-flops 512, the selected subset of information for the desired PE will then be driven to the appropriate flip-flop 512 output. The captured data can then be clocked out of the block using the shift clock.

As described previously, the shift clock provides a separate clock domain for shifting data into and out of block 404. More particularly, the shift clock clocks the capture select data into the capture chain, controls block 502 and match tag register 506. After data has been captured, the shift clock clocks the captured data out of the capture chain. Those skilled in the art will understand how to recover the captured data from all the serial data output from all the blocks.

Although the present invention has been particularly described with reference to the preferred embodiments thereof, it should be readily apparent to those of ordinary skill in the art that changes and modifications in the form and details may be made without departing from the spirit and scope of the invention.

For example, it should be noted that the capture block circuitry could also be adapted to cause data to be loaded into the processing elements via the serial chain. In such an example, further circuitry or functionality could also be added to cause a hold or interrupt to occur when the desired point in a program is reached, at which point data is loaded into, and/or captured from, the programmable fabric.

Many other alternatives and adaptations of the present invention will occur to those skilled in the art after being taught by this disclosure, and it is intended that the appended claims encompass such changes and modifications.

What is claimed is:

1. An apparatus for capturing data from a fabric having a plurality of programmable processing elements, comprising:
a capture block coupled to the fabric, the capture block being responsive to first capture select information to controllably capture first data from certain of the processing elements during a first operation of the fabric, the capture block being responsive to second different capture select information to controllably capture second data from the same or other certain of the processing elements during a second operation of the fabric.

2. An apparatus according to claim 1, wherein the first and second operations are performed in real-time using a normal system clock of the fabric.

3. An apparatus according to claim 2, wherein the first and second capture select information is provided to the capture block using a shift clock that is separate from the system clock.

4. An apparatus according to claim 3, wherein the shift clock also is used to retrieve the captured first and second data from the capture block.

5. An apparatus according to claim 1, wherein the processing elements include a plurality of registers, and wherein the first and second capture select information selects certain of the registers, and the first and second data comprise data from the certain registers.

6. An apparatus according to claim 1, wherein the processing elements are arranged in the fabric in a plurality of stripes, and wherein the certain processing elements selected by the first capture select information are in only a first one of the stripes, and wherein the certain processing elements selected by the second capture select information are in only a second different one of the stripes.

7. An apparatus according to claim 6, wherein the stripes execute respective steps of a program, and wherein the first and second capture select information thereby select certain of the steps.

8. A method for capturing data from a fabric having a plurality of programmable processing elements, comprising:
providing first capture select information to a capture block coupled to the fabric to controllably capture first data from certain of the processing elements during a first operation of the fabric; and
providing second different capture select information to the capture block to controllably capture second data from the same or other certain of the processing elements during a second operation of the fabric.

9. A method according to claim 8, wherein the first and second operations are performed in real-time using a normal system clock of the fabric.

10. A method according to claim 9, wherein the steps of providing the first and second capture select information are performed using a shift clock that is separate from the system clock.

11. A method according to claim 10, further comprising:
using the shift clock to retrieve the captured first and second data from the capture block.

12. A method according to claim 8, wherein the processing elements include a plurality of registers, and wherein the first and second capture select information selects certain of the registers, and the first and second data comprise data from the certain registers.

13. A method according to claim 8, wherein the processing elements are arranged in the fabric in a plurality of stripes, and wherein the certain processing elements selected by the first capture select information are in only a first one of the stripes, and wherein the certain processing elements selected by the second capture select information are in only a second different one of the stripes.

14. A method according to claim 13, wherein the stripes execute respective steps of a program, and wherein the first and second capture select information thereby select certain of the steps.

15. An apparatus comprising:
a programmable fabric comprising a plurality of processing elements arranged in a plurality of stripes, the fabric operating in real time according to a system clock; and
a plurality of capture blocks respectively coupled to the plurality of stripes, the capture blocks being responsive to a shift clock to receive capture select information,
wherein during a first real time operation of the fabric, the capture block uses first received capture select information to controllably capture first data from certain of the processing elements,
and wherein during a second real time operation of the fabric, the capture block uses second different received capture select information to controllably capture second data from the same or other certain of the processing elements.

16. An apparatus according to claim 15, wherein the processing elements include a plurality of registers, and wherein the first and second capture select information selects certain of the registers, and the first and second data comprise data from the certain registers.

17. An apparatus according to claim 16, wherein the capture blocks include a serial chain of logic elements respectively coupled to each of the registers of each of the processing elements in the associated stripe.

18. An apparatus according to claim 17, wherein the shift clock is used to serially clock data in and out of the serial chain.

19. An apparatus according to claim 15, wherein the certain processing elements selected by the first capture select information are in only a first one of the stripes, and wherein the certain processing elements selected by the second capture select information are in only a second different one of the stripes.

20. An apparatus according to claim 19, wherein the stripes execute respective steps of a program, and wherein the first and second capture select information thereby select certain of the steps.
